(19) United States
(12) Patent Application Publication
(10) Pub. No.: US 2023/0116407 A1
(43) Pub. Date: Apr. 13, 2023

(54) Systems and Methods for Predicting Consumer Spending and for Recommending Financial Products

(71) Applicant: Soon Science Inc., Houston, TX (US)

(72) Inventors: You Chang Yoon, Houston, TX (US); Mike Horia Mihail Teodorescu, Cambridge, MA (US); Stephen Joseph Schwee, Chicago, IL (US); Matthew Callaway Rice, Kennesaw, GA (US); Edward Ha, Chicago, IL (US)

(73) Assignee: Soon Science Inc., Houston, TX (US)

(21) Appl. No.: 17/910,798

(22) PCT Filed: Apr. 11, 2021
(86) PCT No.: PCT/US2021/026766

§ 371 Date: Sep. 10, 2022

Related U.S. Application Data
(60) Provisional application No. 63/008,734, filed on Apr. 11, 2020.

(51) Int. Cl. G06Q 40/02

(52) U.S. Cl. CPC G06Q 40/02

(57) ABSTRACT

Systems and methods for predicting consumer spending and the financial outcomes of using specific credit cards and other financial products are disclosed. Systems and methods for recommending credit cards to consumers and for backtesting consumer behavior data are further disclosed. The system and methods may be used to help consumers find and chose credit cards, debit cards, and other financial products which are suitable to their financial circumstances. A financial outcome prediction system configured to determine financial outcome parameters of a user using a credit card during a future time period is disclosed. The financial outcome parameters may include an overall card value obtained by adding and subtracting the monetary values of reward parameters, fee parameters and other benefits associated with the credit-card.

### CROSS REFERENCE TO RELATED APPLICATION

This application claims priority from and the benefit of U.S. Provisional Patent Application No. 63/008,734 filed on Apr. 11, 2020 and titled “Systems and methods for backtesting consumer behavior data to help consumers make optimal decisions”, invented by You Yoon, which is hereby incorporated by reference for all purposes as if fully set forth herein.

### BACKGROUND OF THE INVENTION

### I. Field of the Invention

Exemplary embodiments of the present invention relate to systems and methods for testing consumer behavior and for assisting consumers to select financial products suitable to their circumstances.

### II. Discussion of the Background

The credit card business field and market are very large. It is estimated that in the United States alone there were 1.1 billion credit cards in the year 2018. It is also estimated that in 2019 the total consumer credit card debt in the United States was about $1.08 trillion.

A major challenge that consumers face when researching or signing up for a credit card is the amount of unknown that they face. In order to entice users to sign up for credit cards, credit cards advertise rewards, benefits, first time offers, and others. However, consumers often do not have good knowledge of their spending habits and do not have a clear understanding of the many aspects/factors which may be relevant to making good choices regarding financial products such as credit cards. As a result, quite often the decisions made by consumers regarding choice of financial products are not well informed and are not based on good visibility in all relevant financial circumstances. The choices and selections made by consumers are often based on guessing and incomplete information. Often consumers select a credit card based only on a few hours of research on several credit cards aimed at determining if the rewards and benefits of the several researched credit cards make sense to them. Moreover, there are hundreds of cards that a user needs to scan through and to understand the pros & cons and the reward structure for each card in order to decide on selecting a card.

Consumers research for new credit cards by using a multitude of resources ranging from websites, blogs, ads, family and friends, etc. From discovering new cards to analyzing the pros and cons of each card, finding a credit card is a very time consuming and disjointed process that often leaves many users frustrated, exhausted, and unsure if they had made the right choice. Most of the time, they will never know if they had made the right choice.

A typical user shopping for a credit card goes through the following process and stages: 1) discovery stage—surfing the web, trying to find all the potential cards; 2) analysis stage—analyzing the card options, filtering through all the potential cards to narrow down to a couple, and learning about each card to compare the pros and cons of each card; 3) sign up stage—applying for the chosen card, after doing a lengthy research and lots of guessing which is often exhausting. This process can be very time consuming for users.

For a user in the discovery stage, a user may go to an online search engine to search for all the potential credit cards. Many of these results are not personalized and are mostly static lists of “one size fits all” information for tens, if not hundreds, of cards that the user has to investigate. When faced with this pain point, the user may defer to blog posts, friends and family, and other lesser-known resources in hope of finding specialized information and more personalized recommendations. However, these resources are often overwhelming to comb through and personalized recommendations such as quizzes are done at a very superficial level. These lesser-known resources, blog posts, and advice from friends and family usually do not provide comprehensive and/or the latest information and require the user to do a follow-up research to confirm the latest updates, reviews, and other relevant information. After a disjointed and clunky experience of researching many different resources to compile a list of shortlisted credit cards, the user can finally enter the analysis stage of the funnel. The user will use the performed research to piece together insights on the shortlisted cards, and spend more time researching details for each card, such as Annual Percentage Rate (APR), rewards, special offers, reviews, etc. After that the user spends additional time analyzing each offer to evaluate how helpful or relevant the offer is to the user. In the analysis stage, the user usually has to make estimates and guess about how beneficial different rewards are. As a result, the decisions made by consumers to select a credit card are not supported by rigorous and systematic analysis and are not well informed.

The process of selecting a credit card for consumers is not only daunting and broken, but also unfair as there is a substantial asymmetry of information in the system. While credit card companies are equipped with large amounts of data and powerful analytics, as well as computation capability, to create reward structures that are beneficial for them, an average consumer is ill equipped with the necessary resources to understand and evaluate which card would give them the best benefit. The typical consumer does not have access to predictive analytics tools to compare their spending to others, nor does the consumer have access to algorithms to model spending scenarios across cards from different banks.

Furthermore, consumers do not typically have access to transaction data, nor even have their own transactions in an easy to use format (many bank systems print statements in PDF format and do not enable easy download of transactions by category or unit of time in an easy to use format like a CSV table). Without a way to do accurate, data-driven, and systematic analysis on different credit cards, consumers are at an informational disadvantage and can be lured in by the initial reward offers that may not ultimately benefit them. This creates a very one sided relationship between consumers and financial institutions, such as credit card companies and banks, that puts consumers at a significant disadvantage. In addition to the lack of systems and methods to empower users to accurately analyze the different cards, there is a complete lack of consumer accessible systems which can be used by consumers to perform both the discovery and the analysis of the cards in an efficient, comprehensive, and personalized manner.

The systems, devices and methods disclosed herein are aimed, among others, at providing solutions to the above mentioned consumer needs and to empower consumers to make better choices for themselves and to reduce the information asymmetry. The systems, devices and methods disclosed herein enable consumers to perform both the discovery and the analysis of credit card offers in a comprehensive, efficient, and personalized manner. The systems, devices and methods disclosed herein are designed to help consumers make informed decisions with respect to selecting financial products, such as credit cards, which are most suitable for their financial needs and circumstances.

The systems, devices and methods disclosed herein may be used for many different user circumstances and financial products and may include testing consumer data, such as spending data, on many (e.g., hundreds) of credit/debit cards in order to find the credit/debit cards that could yielded the most benefits for the users. This will help users in both the discovery and analytics stage. Consequently, instead of surfing the web to find and filter through potential cards and spending lots of time manually analyzing each card, consumers will be able to automatically perform the rigorous analysis of hundreds of cards via reliable methods and systems. As an example of implementations among others, consumers may be able to back test their previous transactions on hundreds of cards, thereby helping the user to easily see what the rewards would have been for each card. This way the user may be able to easily sort and filter through the hundreds of credit card offers and analyze additional metadata and information that could be helpful in making an informed and/or optimal choice.

The above information disclosed in this Background section is only for enhancement of understanding of the background of the invention and therefore it may contain information that does not form any part of the prior art.

### SUMMARY OF THE INVENTION

Exemplary embodiments of the present invention aim to address both challenges of testing consumer behavior on a multitude of financial products, such as credit cards and debit cards, offered online by financial institutions and the challenge of assisting consumers to select, out of hundreds of financial products advertised and offered online, the optimal financial products for their circumstances.

Exemplary embodiments of the invention disclose systems and methods for predicting consumer spending and the financial outcomes of using specific credit cards and other financial products, for recommending credit cards to consumers, and for backtesting consumer behavior data. The system and methods may be used to help consumers make optimal decisions regarding choice of credit cards, debit cards, reward cards and other financial products.

In a disclosed exemplary embodiment, a financial outcome prediction system is configured to determine financial outcome parameters of using a credit card. The system may include a device configured to enable a user to open a user account and a device for accessing user's financial statements from one or more user's financial institutions, wherein the financial statements include a plurality of transactions.

The system may further include a device configured to search a computer network for credit card offers, to receive from computers on the network card information about credit cards and to form a list of credit card records, wherein each of the credit card records is associated with a credit-card. The system may further include a device enabling a user to filter and sort credit card records according to one or more of the financial outcome parameters. The system may be further configured to rank credit card records according to financial outcome parameters, and to display a ranked list of the credit card offers at a user's device. The system may further include a feature enabling users to filter the list of the credit card offers according to one or more card-parameters and financial outcome parameters.

The system may be configured to determine one or more financial outcome parameters corresponding to the user using a credit card during a future time period, wherein the financial-outcome-parameters include one or more of the following: rewards-parameters, benefits-parameters, fees-parameters, overall-card-values.

The system may be further configured to receive user input information from the user and to determine expected user financial circumstances during a future time period, such as: changes in expected spending on certain category of goods and services, changes in expected user income, expected use of other credit cards and payment methods, expected family circumstances. The system may be configured to use the user input information to better estimate the financial outcome parameters.

The system may be further configured to receive, from one or more computers on the network, market information about expected market conditions during the future time-period, such as: expected inflation, expected changes in the price of goods and services, consumer price index estimations based on a basket of goods or similar measures to assess inflation or expected inflation, and expected changes in interest rates, among other measures of macroeconomic patterns and macroeconomic health conditions. The system may be configured to use the user input information to better estimate the financial outcome parameters forecasting likely user spending based on market conditions, including potential changes to existing spending patterns.

The system may be configured to estimate the rewards a user would receive from a certain merchant. The system may be further configured to estimate the rewards a user would receive from purchases in a certain category of goods and services. The system may be further configured to estimate one or more fees and liabilities the user would incur if using the credit-card during the future time period. The system may be further configured to estimate an overall-card-value corresponding to the total overall value the user would receive if using the credit-card during a future time-period. The overall card value may be determined by adding and subtracting the monetary values of reward parameters, fee parameters and other benefits associated with the credit-card.

It is to be understood that both the foregoing general description and the following detailed description are exemplary and explanatory and are intended to provide further explanations of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a diagram of an exemplary embodiment of a financial outcome prediction system configured to exchange information via a computer network, such as the internet, with a plurality of user devices, financial service systems, merchant systems and other auxiliary systems.

FIG. 2 shows a diagram of an exemplary embodiment of a computing device.

FIG. 3 shows a diagram of an exemplary embodiment of a prediction system configured to predict consumer spending and the financial outcomes of a user using specific credit cards.

FIG. 4 shows a diagram of an exemplary embodiment of device-320 for enabling a user to access his/her financial information (e.g. credit/debit card statements) from one or more financial institutions, such as banking institutions.

FIG. 5 shows a diagram of an exemplary embodiment of a consolidated activity report, created by device-320, including a plurality of records.

FIG. 6 shows a diagram of an exemplary embodiment of device-330 for receiving information from users about their current financial circumstances and their future anticipated financial circumstances.

FIG. 7 shows a diagram of an exemplary embodiment of information provided by users regarding anticipated future increase or decrease in spending, expressed in percentage or currency, on certain goods and services.

FIG. 8 shows a diagram of an exemplary embodiment of device-340 for creating a user financial profile by combining information from the user's financial statements obtained from financial institutions with information received from the user.

FIG. 9 shows a diagram of an exemplary embodiment of device-350 for searching for credit card offers, receiving data and information about the credit card offers, and forming/updating a centralized card-offers-database of credit card offers.

FIG. 10 shows a diagram of an exemplary embodiment of a card offer database, created by device-350, including a plurality of card-offer-records.

FIG. 11 shows an exemplary embodiment of the information exchange and information processing performed by device-400 for determining financial outcome parameters corresponding to a user using a credit card.

FIG. 12 shows a diagram of an exemplary embodiment of a user-financial-statement and a corresponding virtual-transaction-statement.

FIG. 13 shows a diagram of an exemplary embodiment of a process for determining one or more financial-outcome-parameters.

FIG. 14 shows a diagram of an exemplary embodiment of a process for determining the total rewards an user would receive from a groceries-vendor during a one year period.

FIG. 15 shows a diagram of an exemplary embodiment of a process, including the use of adjustment-functions, for determining one or more financial-outcome-parameters.

FIG. 16 shows a diagram of an exemplary embodiment of device-500 for listing, ranking, filtering, and recommending credit card offers to an user.

FIG. 17 shows a diagram of an exemplary embodiment of processes performed by device-500 for listing, filtering, ranking and recommending credit cards to users.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art Like reference numerals in the drawings denote like elements.

Systems and methods for predicting consumer spending and the financial outcomes of using specific credit cards and other financial products, for recommending credit cards to consumers, and for backtesting consumer behavior data are disclosed. The systems and methods may be used to help consumers make optimal decisions regarding choosing credit cards, debit cards, loans and other financial products.

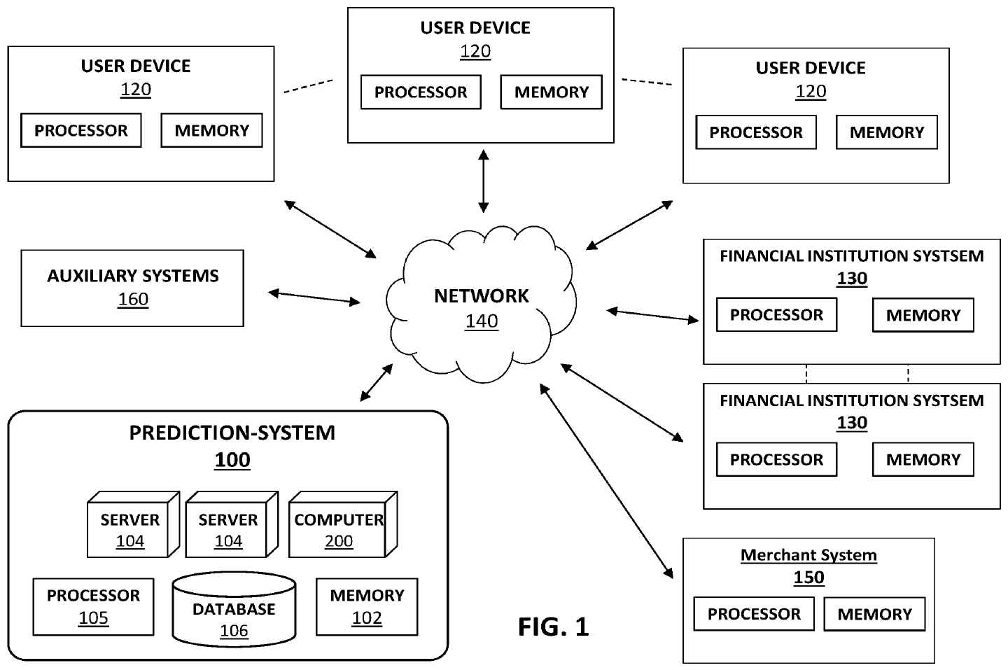

In a first exemplary embodiment, a financial outcome prediction system, hereinafter referred as prediction-system 100 is described hereinafter with reference to FIG. 1. The term “user” is used hereinafter as meaning a user of the prediction-system, such as a consumer using the system with the purpose of finding a credit card suitable for her/his circumstances.

The prediction-system-100 may include one or more computer devices 200, one or more servers 104, one or more processors 105, one or more memories 102, one or more databases 106. The prediction-system-100 is configured to exchange information via a network-140, such as the internet, with a plurality of user-devices-120, a plurality of financial institutions systems-130, a plurality of merchant-systems 150, and other auxiliary systems-160, such as: advertiser systems, financial products rating services, market study systems, financial services system, and others.

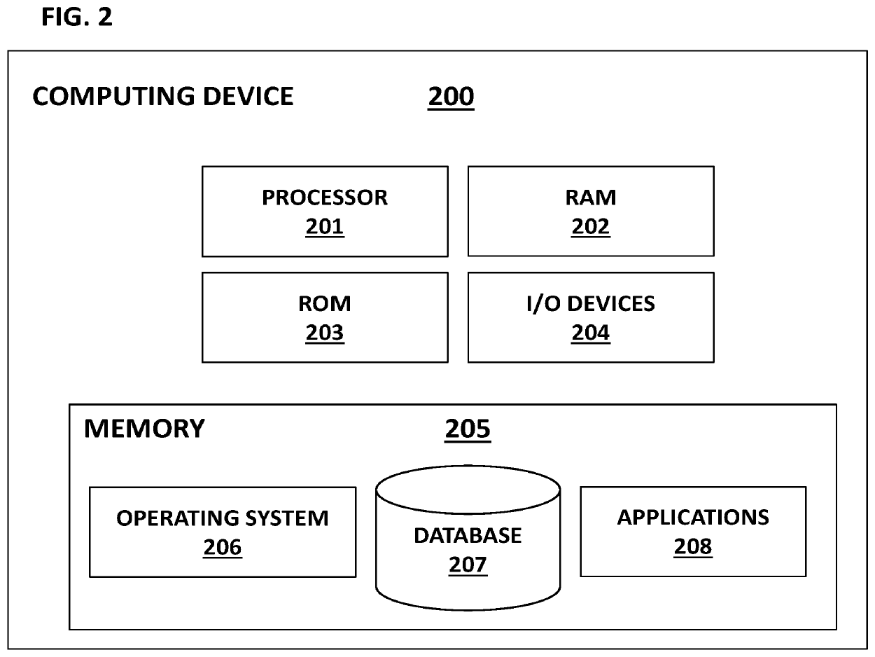

With reference to FIG. 2, the computer devices 200 and the servers may include one or more processors 201, one or more RAM memories 202, one or more ROM memories 203, one or more Input/Output devices 204, one or more memory modules 205. The memory module 205 may include or host an operating system 206, databases 207, and software applications 208. The computer devices and the servers are configured to make computation via the processors; to store information via the RAM and ROM memories and to exchange information with other systems via the network-140. The applications 208 may include one or more applications for testing consumer behavior data and for making recommendations to users regarding credit cards, debit cards and other financial products.

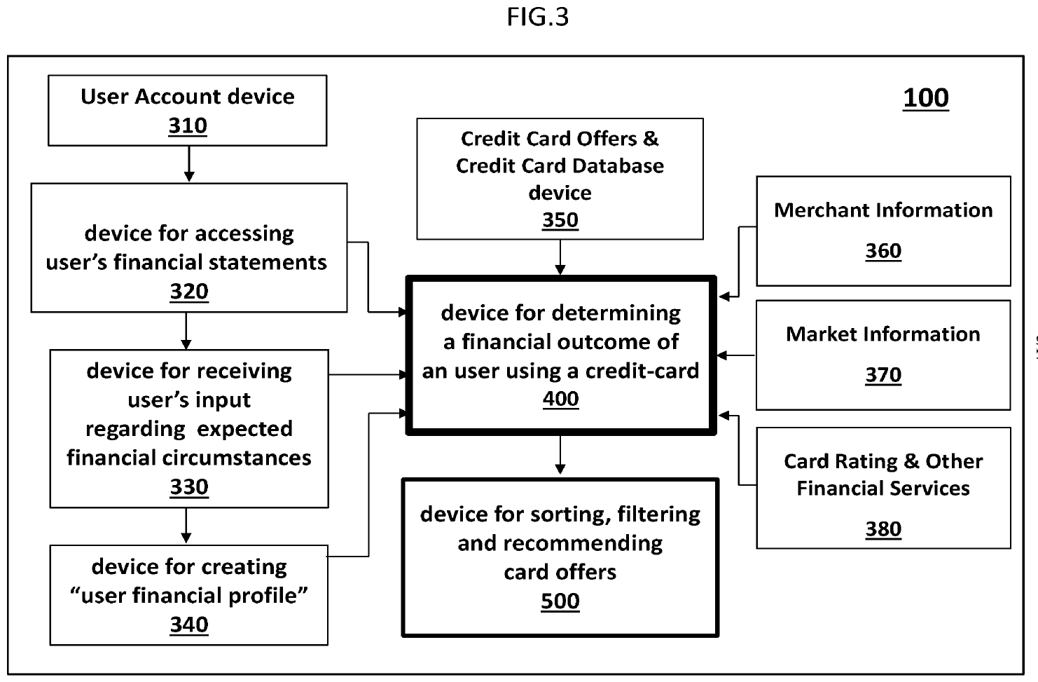

An exemplary embodiment of the prediction-system-100 is described hereinafter with reference to FIG. 3. The prediction-system-100 may include a user account device-310 configured to enable users to open an online user-account on the prediction-system-100, such as a login and password protected user account. The prediction-system-100 may further include a device-320 enabling a user to access his/her accounts with banking and other financial institutions and to cause the transfer of user's financial information, such as bank statements and expense statement, from said banking and other financial institutions.

The prediction-system-100 may further include a device-330 for receiving information from users regarding financial circumstances, such as information not captured by the bank statements and information about their expected future financial circumstances. The prediction-system-100 may further include a device-340 for creating a user-financial-profile based on the user's financial information acquired from the financial institutions by device-320 and on user's financial circumstances acquired from user by device-330.

The prediction-system-100 may further include a device-350 for searching and retrieving information about credit card offers and for forming and maintaining a card offer database including the credit card offers.

The prediction-system-100 may further include a device-360 for acquiring information about merchant financial products (e.g. merchant rewards, merchant cashback). The prediction-system-100 may further include a device-370 for acquiring market-information, such as anticipated inflation rate for the next year, anticipated increase in the price of certain goods and services, anticipated interest rates, etc. The prediction-system-100 may further include a device-380 for acquiring review and rating information from financial services, such as review and rating services for credit cards.

The system-100 may further include device-400 for determining a financial outcome of an user using a credit-card. Device 400 may be configured to determine financial-outcome-parameters corresponding to an user-financial-profile and a credit card. The financial-outcome-parameters may include one or more of the following: total rewards during a certain period of time; customer service rating; availability of support services; fees paid; cashback; airline miles; points for travel, hotels and other services; bonuses, etc. The -financial-outcome-parameters provide information to the user regarding the consequences (financial and others) of choosing a credit card or financial product. The device-400 is further configured to determine financial-outcome-parameters for multiple credit cards and financial products.

The prediction-system-100 may further include device-500 for listing, sorting, filtering and recommending card offers. Device-500 may be configured to create a list and display for the users the credit card outcome for each of the credit-cards. The device-500 is further configured to make recommendations to users regarding choosing a credit-card which fits user's interest and circumstances. Consequently, the user will be able to make informed decisions about the credit card and/or financial product selected.

In an alternative embodiment, the prediction-system-100 may include anonymized data from other users who agreed to share their transactions and credit card choice data anonymously to benefit from decisions from a community of peer users. An anonymous identifier like a GUID may be generated by the system to link user transaction data within a visit to a particular visit outcome, such as: browsing a particular card, selecting to sign on to a particular card, or simply running a backtest on transaction data, amongst other options. The GUID or another internal anonymous identifier may be used to link the outcome of a visit to the existing card or card brands and types in the user's portfolio to their existing category spending and transaction data pulled during the visit. This would enable recommendations of cards based on peer experiences, such as whether fellow users on the platform with similar existing cards and transaction patterns have shown preference for a particular card out of those with information available on the platform. The transaction data may be aggregated to spending categories and converted into a vector space model by techniques, such as taking a percentage of spending per category for the user and placing those key categories and corresponding percentage values in a vector representing spending and linking said vector with the unique visit identifier. The existing credit cards whose transactions were evaluated in the said visit could be encoded in a prediction model, for instance with a separate binary weights initial-cards-vector where a key represents a card identifier and the value represents “0” if the card were not present and a “1” if the card were present in the visit (i.e., the user has the card is encoded with a “1”).

In an another embodiment, a dummy variable may be used to represent each card in a prediction model. The vector of spending categories could then be used across existing peer users who agreed to anonymously share their visit data to compare the spending patterns of the existing user to others on the platform, and can be either included as the set of predictors as is in a model where the outcome is chosen next card and compared to other users whose labels are their chosen card on the platform in a k-nearest-neighbors algorithm, or each element in the spending vector and each element in the initial-cards-vector can become predictors in a multinomial logit model where the outcome choices are the options of cards available to users on the platform. A classification model could then be trained with typical machine learning techniques such as bagging, boosting, cross-validation to name a few. The classification model could be one or an ensemble of models, such as k-nearest-neighbors, multinomial logistic regression, Naïve-Bayes, support vector machines, decision trees, random forests, neural networks, or other supervised learning approaches. The outcome variable in one embodiment could be type of card chosen by the user to sign up for as part of the visit, and, in a non-limiting embodiment, could include other outcomes such as browsing without selecting a card, not browsing through recommended cards, or other outcomes that may be of interest to financial institutions.

In another embodiment, the outcome could be represented as pair of existing cards to new card the user signs up for, a tuple including all previous cards and the new card the user signs up for during the visit, or a different encoding to capture path-dependency between prior cards and a newly signed up card during the visit. In yet another embodiment, the outcome in the prediction may be used to perform churn modeling and determine which users may be decreasing in activity.

In another embodiment, the spending vector could be converted to pair-wise similarity values through cosine similarity, Jaccard similarity, Dice similarity, or others, applied to the vector of the spending of the focal user and comparing the spending to vectors of other users. In another embodiment, the k-n-n distance metric could be chosen such as to maximize classification performance on this vector space, including Minkowski, Manhattan, Chebyshev, Euclidean, any other metric known to those skilled in the art, or any other function that satisfies the properties of a distance function and may be found to maximize algorithm classification performance on this type of data.

In yet another embodiment, the spending vector can be created based on keywords parsed out of the transaction data to generate finer subcategories from the transaction data, and the technique of generating said keywords may include, but not be limited to: individual keywords, keywords found to be most popular in the body of text corresponding to all prior site visits of all users on the platform (which may change dynamically over time), n-grams, or topics obtained through a topic model applied to the transaction data where the text corresponding to each transaction could be considered as a short document. In a non-limiting embodiment, the said keywords could be counted using binary weighting, raw term frequency counts, or relative term frequency techniques such as TF-IDF, such that either the most common transaction keywords or the most unique transaction keywords are included. Other weighting techniques could be included as well. Once the set of transactions is distilled to a vector of keywords, n-grams, or topics, the transaction amounts can be aggregated by unit of time (such as month, quarter, year, etc.), or aggregated by lifetime of the card, or by some other aggregation technique.

1. Device-310 for Forming User Accounts.

In an exemplary embodiment of the invention the user account device-310 is configured to enable the user to open an user account on the prediction-system enabling the user to retrieve information from user's financial institutions and to use the prediction-system to research and select credit cards suitable for user's circumstances. The user-account may be a login and password accessible user account. The device-310 may include security and confidentiality features enabling user to securely transfer information from his/her financial institutions and to use the prediction-system without compromising data security and confidentiality. The device-310 is configured to receive from the user information regarding user's identity, such as user's name and contact information. Device-310 includes one or more processors for performing the above operations, memories for storing information associated with the account, and input/output devices for transferring information to and from user devices.

2. Device-320 for Accessing User's Financial Information from Financial Institutions

Prior spending behavior of users is often highly indicative of their future spending behaviors. A user's credit and debit card statements include complete lists of financial transactions (e.g. purchase of goods/services, money transfers, fees, etc.) conducted by a user during a certain time period (e.g. a month, a year, etc.). Consequently, user's credit/debit card statements provide a detailed picture of all transactions performed via the credit/debit cards during a certain time period in the past. Thus, user's credit/debit card statements provide valuable information which could be used to predict user's future spending behavior.

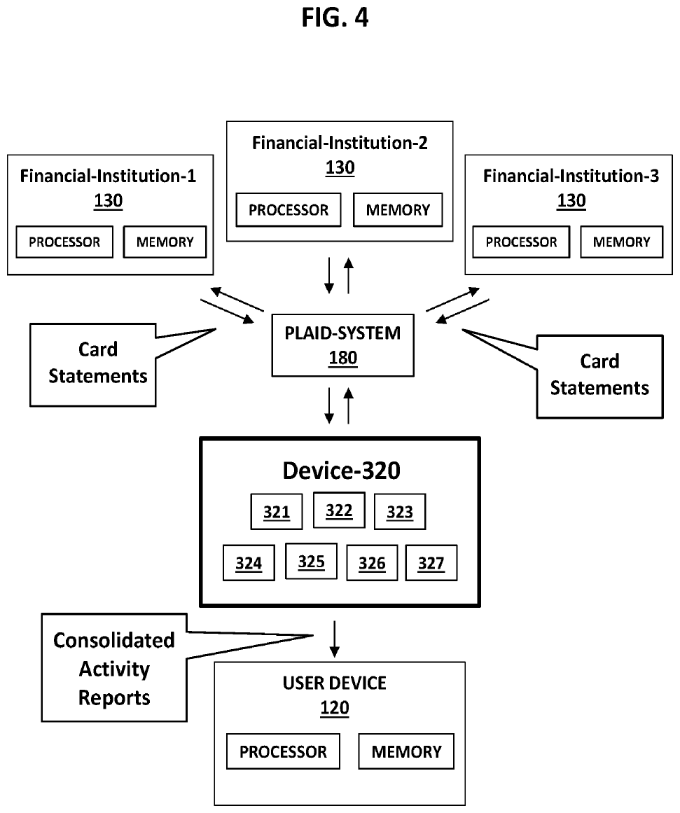

In an exemplary embodiment of the invention, device-320 is described with reference to FIG. 4. Device-320 is configured to enable an user to access his/her financial information (e.g. credit/debit card statements) from one or more financial institutions 130 (e.g. banking institutions). The financial institutions may be referred hereinafter as user-financial-institutions. For example, the user may be enabled to access and download his/her credit card statements, debit card statements, and bank account statements from one or more banks. Users' credit card statements, debit card statements, and bank account statements may be referred hereinafter as user-financial-statements.

The device-320 may further include a device-321 enabling the user to search financial institutions, such as banks, at which the user holds an account, such a credit card account or a debit card account (i.e. the user-financial-institutions). The device-321 may further enable the user to select, from a list of financial institutions, the user-financial-institutions from which user may want to retrieve/download user-financial-statements.

The device-320 may further include a device-322 enabling the user to access and retrieve the user-financial-statements from one or more of user's accounts. In an exemplary embodiment, the device-322 may employ a financial service such as the one provided by PLAID 180 (financial services company doing business via www.plaid.com) to transfer the user-financial-statements from the financial institution to the device-320. The device-322 is configured to securely transfer the user-financial-statements from the user's bank accounts to the device-320. The user-financial-statements (e.g. credit card statements, debit card statements, bank account statements) may include a plurality of transaction-records, such as: purchasing certain goods and/or services, performing money transfers, payment of credit card bills, payment of fees, payment of interest.

A transaction-record for purchasing goods and/or services may include one or more of the following transaction-parameters: transaction-date, transaction-amount, vendor/merchant, category of goods/services, etc. A transaction record for a money transfer may include one or more of the following transaction-parameters: transaction-date, money-transfer-service, transaction-amount, fees, category. A transaction record for a card payment may include one or more of the following transaction-parameters: transaction-date, transaction-amount, fees, category.

Device-320 may include a device-323 configured to display at a user's device a list of the transactions-records and to enable the user to sort and filter the list according to the transaction-parameters.

The device-320 may further include a device-324 configured to form a consolidated-transactions-statement including the transactions of one or more user-financial-statements. The consolidated-transaction-statement may include a list of transaction-records corresponding to the transactions for purchase of goods/services from substantially all user-financial-statements, wherein said transaction-records are sorted by one or more transaction-parameters, such as transaction-date.

The device-320 may further include a device-325 configured to calculate a plurality of activity-parameters associated with user financial statements. In an exemplary embodiment, device-325 may be configured to calculate the total user' spending in a certain category of goods/services during a certain period of time. For example, the device-325 may calculate the total spending in the “groceries” category by adding the transaction-amount of all transactions that have the category parameter equal to “groceries”.

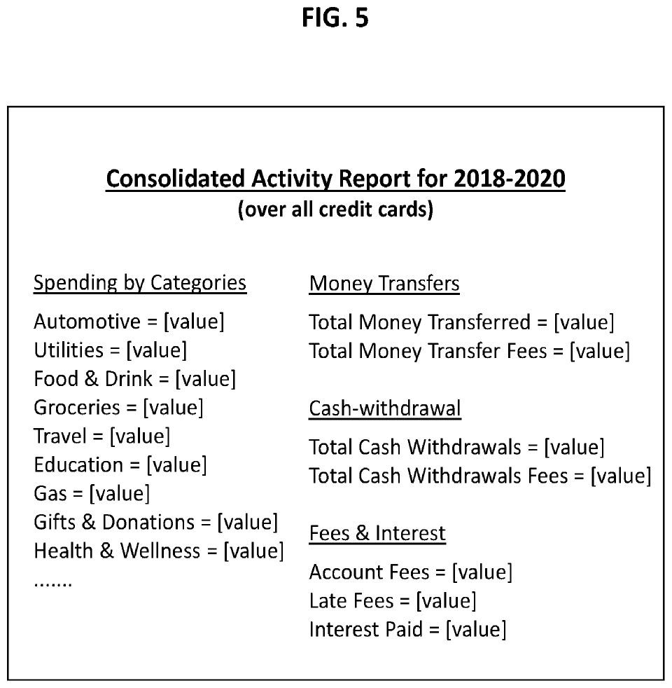

The device-320 may further include a device-326 configured to form a consolidated activity-report including a plurality of records, such as shown in FIG. 5. The records may include activity-parameters providing information about user's spending in a certain category of goods/services during a certain time period (e.g. healthcare spending, automotive spending, utilities spending, restaurant spending, travel spending, gas spending, groceries spending, entertainment spending, etc.). The consolidated-activity-report may further include a plurality of records providing information about money-transfers performed by user in a certain time period (e.g. year 2020) and the corresponding transfer fees paid. The consolidated-activity-report may further include a plurality of records providing information about fees (e.g. account fees, late fees), annual percentage rate, and interest paid by the user in a certain period of time (e.g. one year). The consolidated-activity-report may further include a plurality of records providing information about total cash withdrawals and the corresponding fees paid during a certain time period (e.g. year 2020). The device-326 may be configured to display the consolidated-activity-report at a user device, such as a computer or a mobile device.

The information acquired via device-320, the user-financial-statements, the consolidated-financial-statements and the consolidated-activity-reports may be stored as data files and data structures on one or more memories and computers of the prediction-system 100. The device-320 may include a security-device-327 ensuring that all operations (e.g. data transfer, storage, and processing) are performed securely and confidentially.

Each of the devices 320 to 327 may include one or more processors for performing the above operations, memories and databases for storing information associated with the financial-statements and activity reports, and input/output devices for communicating with and transferring information from financial institutions and auxiliary services such as PLAID.

3. Device-330 for Receiving Input from Users

The information obtained from user-financial-statements (such as the info received via device-320) often does not capture users' complete financial circumstances. Consequently, the information obtained from the user-financial-statements alone does not allow for accurately predicting future spending behavior of users. In order to better capture users financial circumstances, the systems and methods disclosed herein are configured to receive from users additional information about their financial circumstances (i.e. in addition to the information which can be obtained from user-financial-statements). This additional information may be referred hereinafter as user-input-information and may be used, in conjunction with the information in the user-financial-statements and other information, to better predict users' future spending behavior.

In addition, many people do not want to provide access to their bank accounts and/or would prefer to use the prediction system by providing their financial information manually (e.g. by filling out forms and answering quizzes/questionnaires about their financial circumstances). The systems and methods disclosed herein are configured to enable users to manually provide financial information about their credit card spending history.

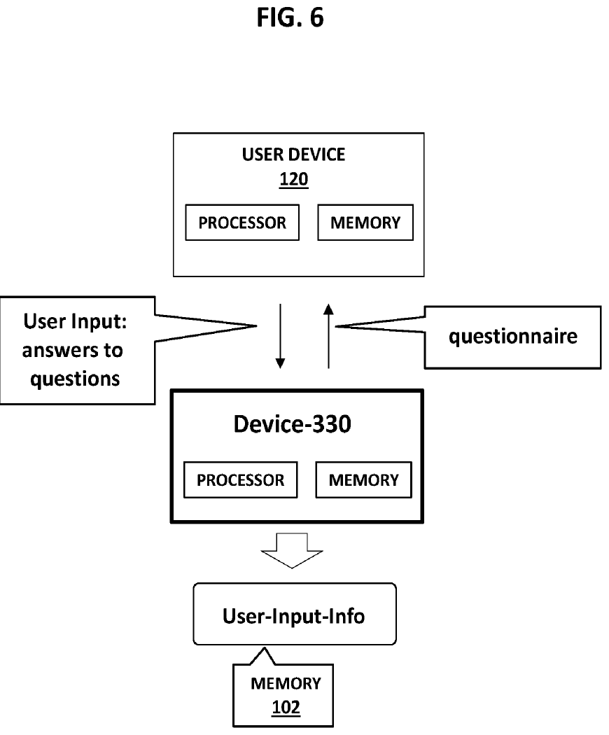

In an exemplary embodiment of the invention device-330 is described with reference to FIG. 6. Device-330 is configured to receive from a user information regarding the user's financial circumstances. Device-330 may be configured to provide users with an interactive online form or questionnaire enabling users to answer a set of questions or to manually provide information about user's present-financial-circumstances and/or expected-future-financial-circumstances.

The user-input-information may include one or more of the following: information about user past spending over a period of time (e.g. past one year or past three years); information about user's past spending in a certain category of goods and/or services during a certain time period (e.g. groceries spending, healthcare spending, restaurant spending, travel spending, gas spending, wellbeing spending, entertainment spending, etc.); information about money-transfers and cash withdrawals effectuated by the user; information about user's income over a past period of time; and information about user's family size and dependents.

The user-input-information may further include information about user's expected future circumstances (hereinafter referred as user-expected-future-circumstances). The information about user-expected-future-circumstances may include one or more of the following: information about the total user-expected-spending over a time period in the future (e.g. one year, three years, ten years); information about user-expected-spending in a certain category of goods/services during a certain time period in the future (e.g. healthcare spending, restaurant spending, travel spending, gas spending, groceries spending, wellbeing spending, entertainment spending, rent, housing, taxes, etc.); information about user's expected income over a future period of time; and information about expected user's family size and dependents over a future period of time.

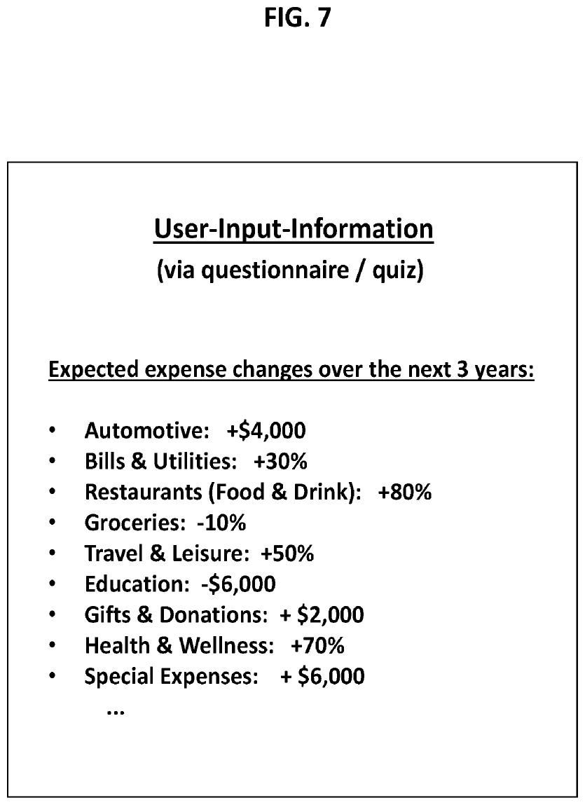

In an exemplary embodiment, the user may be enabled to provide information about the anticipated increase/decrease (expressed in percentage or currency) in spending on certain categories of goods/services, such as shown in FIG. 7.

The user-input-information may further include information about user's expected use of the credit card which the user is searching for and intends to choose (hereinafter referred as selected-credit-card), such as: the specific category of goods/services the user intends to use the credit card for; information about the other credit/debit cards and payment methods (e.g. PayPal, checks, cash) the user anticipates will use concomitantly with the selected-credit-card; and the share of expenses, out of the entire user-expected-spending performed via all user's cards and payment methods in one or more categories of goods and services, the user expects will be performed via the selected-credit-card. For instance, the user-input-information may include information providing that user expects that only a fraction (e.g. 30%) of all user-expected-expenses in the air-travel category of goods/services will be made via the selected-credit-card.

The user-provided-information may further include information about the actual persons who will use the credit card on behalf of the user (e.g. user's children, user's wife, user's dependents, user's employees/contractors) and the expected categories of goods/services.

In an exemplary embodiment of the invention, device-330, and the questionnaires used by device-330, may be configured to receive from users information about financial circumstances not captured by users' bank statements and/or by the information received via device-320 for accessing user's financial information from financial institutions.

In an exemplary embodiment of the invention, device-330, and the questionnaires used by device-330, may be configured to receive information from users who cannot (or don't want to) provide access to their bank accounts/bank statements or from users who prefer to enter manually (e.g. by filing an online form) information about their spending behavior. In this case there will be no user-financial-statements that prediction-system-100 can use, and consequently prediction-system-100 may use only the user-input-information, the information received via devices 360-380; and other auxiliary information.

The information acquired via device-330 may be stored as data files and data structures on one or more memories and computers of the prediction-system 100. Device-330 includes one or more processors for processing information received from users, memories for storing information from the users, and input/output devices for transferring information to and from user's devices.

4. Device-340 for Creating a User-Financial-Profile

In many situations neither the user-financial-statements received via device 320 nor the consolidated-activity-reports created by device 320 provide user with a clear and accurate picture of user's financial circumstances. Moreover, in many situations user-input-information, received from user via device-330, may not provide a clear and accurate picture of user's financial circumstances because the information received from users is often less than accurate. Accordingly, there is a need for synthesizing all available information about user's financial circumstances (e.g. the information received via device-320 and device-330) into a user-financial-profile including all information about user financial circumstances, wherein the user-financial-profile is expressed in a format that would enable users to better understand their financial circumstances and that would be suitable for use by device-400 and by other financial services and software applications.

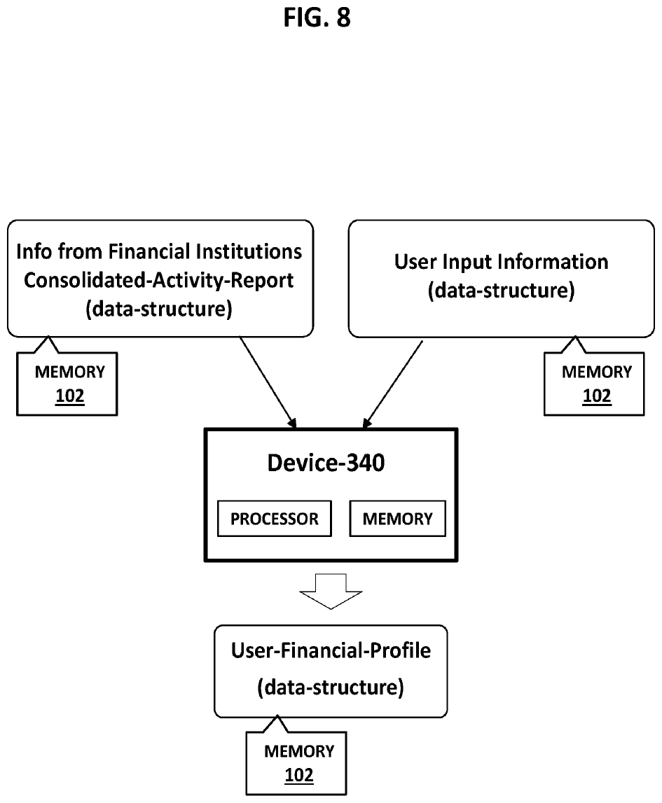

In an exemplary embodiment of the invention device-340 is described with reference to FIG. 8. Device-340 is configured to create a user-financial-profile by combining and synthesizing information in one or more of the following: user-financial-statements, user-input-information, consolidated-transaction-statement, consolidated-activity-report, and other information about users financial circumstances. The user-financial-profile may be stored as data files and data structures on one or more memories and computers of the prediction-system 100.

The user-financial-profile may include the records included in user-financial-statements, such as transaction-records of bank-statements received by device-320. The user-financial-profile may include records of the consolidated-activity-report created by device-320. The user-financial-profile may include records of the user-input-information created by device-330. The user-financial-profile may include records formed by combining, via mathematical operations, records of the user-input-information with records of the user-financial-statements. For example, the records of the user-financial-profile may include one or more of the following: estimated income in a time period (e.g. the next one year, or next two years, or next three years); estimated total spending in a certain category of goods in a time-period; estimated tax payments a in time-period; estimated number of dependents during the time-period.

The user-financial-profile may be configured to include records and information stored in a format which are matching the information and format needed by device-400 to determine the projected-financial-outcome corresponding to an user using a specific credit-card offered by various financial institutions via website of the world wide web (e.g. the credit-card offers received by device-350).

The device-340 may be configured to display the user-financial-profile on a monitor included on a user device (e.g. a computer or a mobile device) in a user-friendly manner such as to enable the user to understand his/her financial circumstances. The displayed user-financial-profile may show records and list of records. The device 340 may be configured to enable the user to sort and filter through records according to various parameters. Device-340 includes one or more processors for processing the information received from device-320 and device-330, memories for storing information the data-structures associated with the user-financial-profile, and input/output devices for transferring information to user devices.

5. Device-350 for Accessing Credit Card Offers

There are a large number of credit card offers advertised on the web via websites, social media platforms, emails, and others. However, the credit card offers are often dispersed over thousands of websites and there are few or no centralized places (e.g. publicly accessible database or websites) where users can see and compare all credit-cards via one single application. Accordingly, there is a need for a centralized place (e.g. database or website) bringing together a large number of credit card offers (e.g. as many as possible) and their associated data. In addition, in order to help users select the credit card most suitable to their circumstances, it is necessary to obtain data and information about as many credit card offers as possible and to evaluate the benefits users would receive from selecting the offered credit cards.

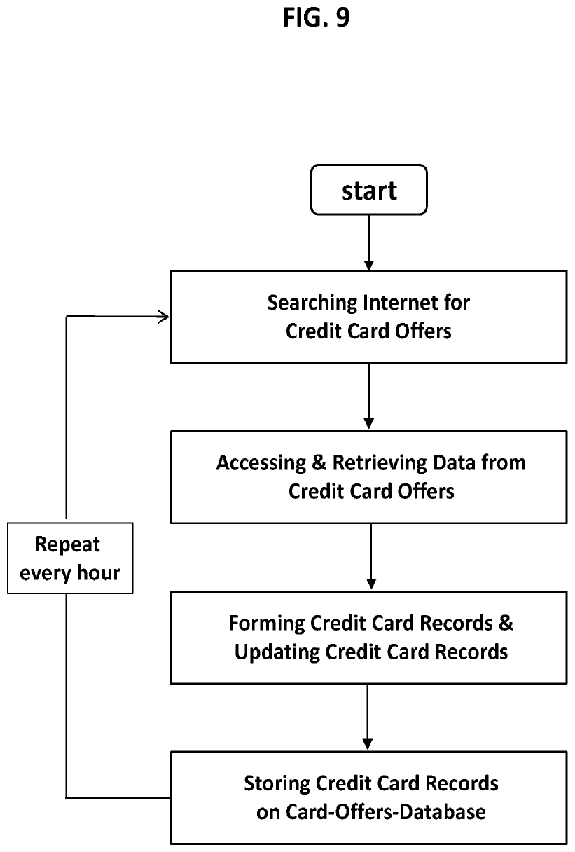

In an exemplary embodiment of the invention device-350 for searching for credit card offers, receiving data and information about the credit card offers, and forming/updating a centralized database of credit cards offers is described with reference to FIG. 9. Device-350 may be configured to search the internet network (e.g. websites, social media sites, advertisers) for credit card offers and to access information, stored on memories and databases of the internet network, associated with each of the credit cards corresponding to said credit card offers.

Device-350 may further be configured to extract data associated with the credit card offers (e.g. via a data-scraper) from webpages on which the credit card offers are advertised. Device-352 may be further configured to use the extracted data from a credit card offer in order to create a card-info-record for each credit card offered. The card-info-record may include one or more card-parameters, wherein each of the card-parameters provides information about one or more of the following: name and identification info of card provider (e.g. Citibank, Amazon, Walmart), name and identification info of the card (e.g. Chase Sapphire Preferred Card), rewards rate, rewards limits, rewards formulas, credit card fees, interest rate, credit limit, cash limit, insurance policies, anti-theft protections, security levels, card ratings, customer support level, and other features associated with the card offer.

The card-parameters may be configured such as to include information which may be used, in conjunction with a user-financial-profile and other information (e.g. such as the information received at devices 360-380), to calculate a projected-financial-outcome of the user using the credit card during a future time period (e.g. one year, two years, three years).

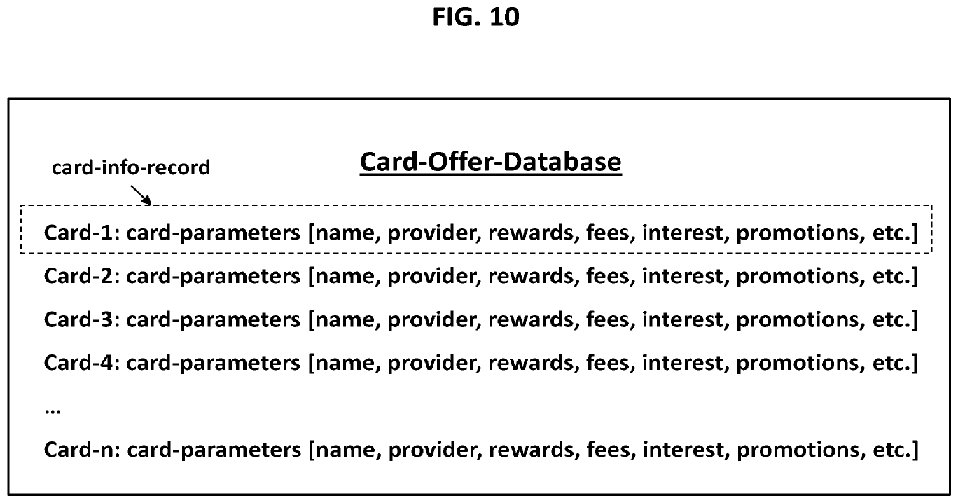

Device-350 may be configured to create and update a card-offers-database (as shown by FIG. 10), wherein the card-offers-database includes a plurality of card-info-records, wherein each of the card-info-records corresponds to a credit card offer. For clarity, for each of the credit card offers, a card-info-record will be created and stored on the card-offer-database. The card-offers-database may be stored on one or more memories, servers and computers of the prediction-system-100.

Device-350 is configured to periodically (e.g. every 1 hour) search the web for credit card offers and to return to the device-350 information about the found credit card offers. Device-350 is further configured to add to the card-offer-database the newly found credit card offers. In addition, the device-354 is further configured to verify for each of the existing card-info-records whether the information associated with the card offers has changed and to update the existing card-info-records with the returned updated information. This way the card-offer-database is periodically updated with the latest information about credit card offers. Device-350 includes one or more processors for performing the searching of the computer networks (e.g. internet) and for performing data retrieving operations, memories for storing the information received from the network, and input/output devices for transferring information, via the computer network, to and from computers and servers storing information about credit-card-offers.

The financial outcome of an user selecting and using a certain credit card is dependent not only on user's financial circumstances and the credit card parameters but also on market circumstances (e.g. inflation rate, variation in the price of certain goods and services, interest rates); merchant/vendors commercial offers (e.g. merchant/vendors' rewards, vendors promotional offers, etc.); laws and policies (e.g. changes in tax laws, changes in banking/insurance laws and policies); and others.

6. Device-360 for Receiving Merchant Information

The device-360 may be configured to receive information about various rewards and benefits provided by merchants to credit card users, which will be referred hereinafter as merchant-data. The merchant-data associated with a certain merchant may include merchant-parameters such as: merchant-rewards-rate, merchant-rewards-limits, merchant cashback; merchant-spending-limits and others. The device-360 may be configured to create merchant-rewards-formulas for calculating rewards, cashback, and other benefits a user may receive from a merchant when performing one or more transactions via a certain credit card. Device-360 includes one or more processors for performing the searching over the internet for merchant information and for retrieving merchant-data, memories for storing the merchant-data, and input/output devices for transferring information, via the computer network, to and from computers and servers storing information about the merchants.

7. Device-370 for Receiving Market Information

The financial outcome of a user selecting and using a certain credit card may depend on market circumstances. The device-370 may be configured to receive market-information from one or more parties about expected market circumstances for future time-periods (e.g. one year, two years, five years). The market-information may include one or more of the following: expected inflation rate; expected variations in the price of certain goods and services; expected variations in risk factors; anticipated interest rates; etc. Device-370 includes one or more processors for performing the searching over the internet for market information and for retrieving market data, memories for storing the market-data, and input/output devices for transferring information, via the computer network, to and from computers and servers storing information about the market.

8. Device-380 for Receiving Information About Card-Quality-Factors

The device-380 may be configured to receive information from third parties (e.g. credit card rating agencies, financial products rating agencies, security level rating agencies, insurance rating agencies) about various card-quality-factors associated with credit card offers. The quality-factors may include: card security level, card ease of use (user friendly), antitheft insurance and/or protection level, value of customer support; etc.

9. Device-400 for Determining the Financial Outcome of an User Using a Credit Card

Customers trying to find and select credit cards on the world wide web desire to choose credit cards which best suit their needs and circumstances. One of the primary criteria a person uses to select a credit card has to do with the rewards the person would receive from using the credit card. Many users are likely to want to maximize the total rewards a card would provide them. Some users want to maximize the rewards in a certain category of goods and services. Many users are likely to want a credit card which would maximize the rewards while satisfying some other criteria, such as: the credit card has a high enough credit limit; the credit card provides good anti-theft protection; the credit card is rated as highly secure; the credit card can be easily used in foreign countries; etc. Determining with a high degree of accuracy the rewards that a user would receive if the user selects a certain credit card poses many challenges.

The financial outcome prediction system-100 may include device-400 for determining a projected-financial-outcome of a user using a card in the card-offer-database during a time-period. The projected-financial-outcome may include one or more financial-outcome-parameters, such as: overall-card-value; total-card-rewards; total-cashback; total-fees; total-merchant-rewards; total-merchant-cashback; transaction-rewards; transaction-fees; total-merchant-fees; security-level; rewards from specific merchants; rewards in a certain category of goods and services; antitheft-protection-level; etc.

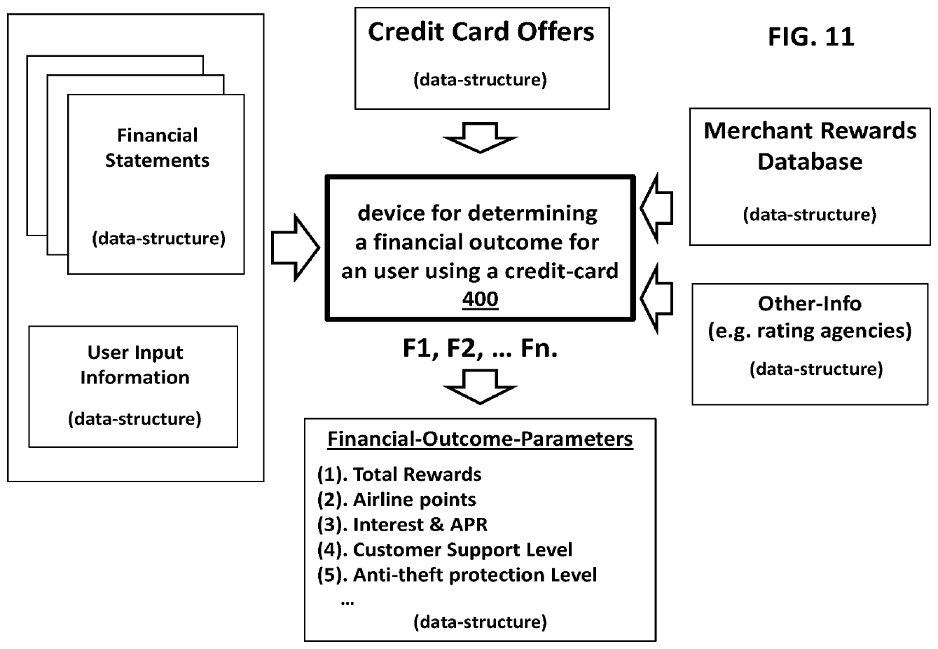

In an exemplary embodiment of the invention, device-400 is described with reference to FIG. 11. Device-400 includes processors for performing the operations and calculations associated with determining financial outcomes and memories for storing information such as financial-outcome-parameters and parameters-functions, and communication devices for communicating with the other devices of the system-100.

For clarity, in the next paragraphs, the functioning of device-400 will be explained with reference to a certain user (i.e. user-A), a certain card in the offered-cards-database (i.e. card-A), and certain time-period (i.e. period-A). Consequently the methods for determining projected-financial-outcome and financial-outcome-parameters will be explained with reference to the certain user (i.e. user-A), the certain card in the offered-cards-database (i.e. card-A), and the certain time-period (i.e. time-period-A). In a first exemplary embodiment, time-period-A has the same length as the time-length of the user-financial-statements. For example, if the user-financial-statements are for transactions performed during a one-year period, then the future length of time-period-A is one year.

For user-A, card-A, and time-period-A, the device-400 may be configured to access/receive one or more of the following: user-financial-statements received at device-320, the user-input-information received at device-330, user-financial-profile at device-340, the card-offer-record for card-A at device-350, merchant-data received at device-360, market-information received at device-370, and other auxiliary information such as regarding card-quality-factors at device-380. The device-400 may use the information received from devices 310-380 to determine financial-outcome-parameters, such as: overall-card-value; total-card-rewards; total-cashback; total-fees; total-merchant-rewards; total-merchant-cashback; transaction-rewards; projected-rewards value for transactions satisfying certain criteria; projected card fees for transactions satisfying certain criteria; transaction-fees; total-merchant-fees; security-level; antitheft-protection-level; etc. The rewards and projected-rewards referred to hereinafter may be expressed in various currency (e.g. US, foreign, crypto-currency), airline miles, points, etc.

The device-400 may calculate the financial-outcome-parameters (e.g. total-card-rewards; total-merchant-rewards; etc.) as described hereinafter.

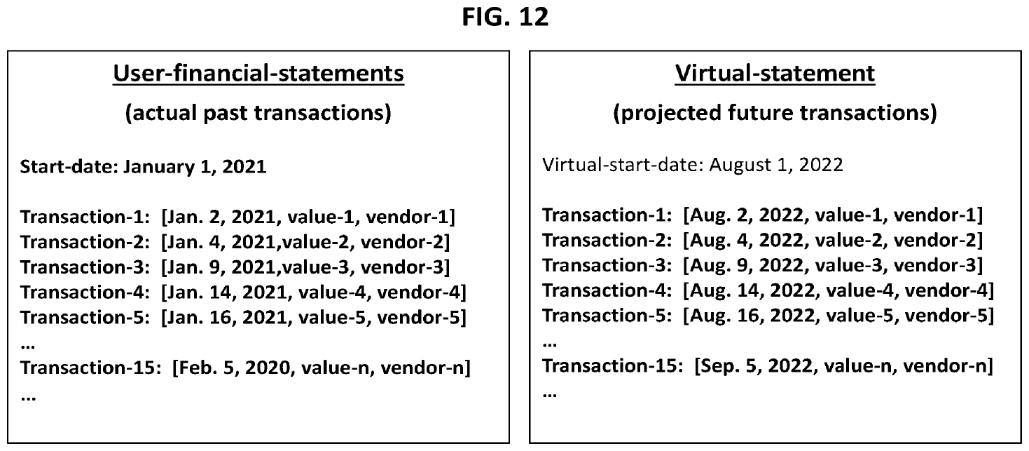

For each user-financial-statement, the device-400 may form a virtual-transactions-statement corresponding to the user-financial-statements, as explained hereinafter with reference to FIG. 12. A virtual-transaction-statement is configured to include transaction-records which are identical with the in the user-financial-statements except that: (1). the start date of the virtual-transaction-statement (i.e. virtual-start-date) is set to the first day of the time-period for which the projected-financial-outcome is determined (e.g. the start-date may be a day in the future, such as the first day of the next month after the user uses the prediction-system); (2). For each transaction in the virtual-transaction-statement, the transaction-date is set to be equal to the virtual-start-date plus a number of days equal to the difference between the corresponding transaction-date in the user-financial-statement and the start-date in the user-financial-statement. For example, as seen in FIG. 12, the transaction-date for transaction-5 in the virtual-statement is 16 days after the virtual-start-date which is the same number of days from the start date (i.e. 16 days) for the corresponding transaction-5 in the user-financial-statement.

Device-400 may be further configured to form a virtual-consolidated-activity-report including activity-parameters corresponding to the transactions in the virtual-transactions-statement and providing information about user's projected spending in a certain category of goods/services (e.g. healthcare spending, restaurant spending, travel spending, gas spending, groceries spending, wellbeing spending, entertainment spending, etc.) during a time-period of the virtual-transactions-statement.

For the selected card-A, the device-400 may be configured to retrieve the card-offer-record and the corresponding card-parameters (e.g. rewards percentage rate, rewards limit, rewards conditions). Using the information in the card-offer-record, the device-400 may be configured to create one or more financial-outcome-parameter-formulas and/or financial-outcome-parameter-calculation-processes (e.g. rewards-formulas and/or rewards-calculation-processes) for calculating financial-outcome-parameters for specific transactions or for a set of transactions in the virtual-financial-statements. The formulas and/or the calculation-processes may use one or more of the card-parameters included in the card-offer-record.

Device-400 may be configured to use merchant-data and card-parameters (e.g. rewards rate, rewards limit, fees, etc.) to form, for each of the financial-outcome-parameters, a corresponding outcome-functions. Device-400 may be configured to use card information (as the one received at device-350), merchant information (as received at device-360), market information (as received at device-360), user-input-information (as received at device-330) to form the outcome-functions corresponding to the financial-outcome-parameters. In a first exemplary embodiment the outcome-functions are configured to receive a virtual-transactions-statement as function argument and to return one or more outcome-function-values, each of the returned outcome-function-values corresponding to a financial-outcome-parameter. The outcome-functions may be obtained by combining two or more functions (i.e. applying one function to the results of another) and by performing function operations such as addition, multiplication and any other operations. In an exemplary embodiment of the invention, outcome-functions may be calculated by combinations of selection-functions and transaction-functions as explained hereinafter.

Device-400 may be configured to use merchant-data and card-parameters (e.g. rewards rate, rewards limit, fees, etc.) to form one or more selection-functions. The selection-functions may receive virtual-transactions-statements as function's argument and may be configured to select specific transactions in the virtual-transactions-statements. The selection-functions may be configured to return/select a set-of-transactions (i.e. selected-transactions) including only the transactions satisfying certain conditions, such as: transactions in a certain category of goods/services (e.g. groceries), transactions with a certain merchant (e.g. Whole Foods), transactions in a certain time-span (e.g. first two weeks of November), transactions for an amount larger than a certain threshold, etc.

Device-module-400 may be configured to use merchant-data and card-parameters (e.g. rewards rate, rewards limit, fees, etc.) to form one or more transaction-functions. A transaction-function may receive as function's argument a set-of-transactions (e.g. a subset of transactions of the virtual-transactions-statement) and may be configured to return a transaction-function-value. For example, the transaction-function may be configured to retrieve from each of the transactions in the set-of-transactions a transaction-amount and a merchant; to calculate a transaction-reward corresponding to each of the transactions; and to sum up all the transaction-rewards; the obtained value may thereby constitute the return of a transaction-function configured to calculate the rewards a user would obtain if user would perform the set of transactions via the credit-card.

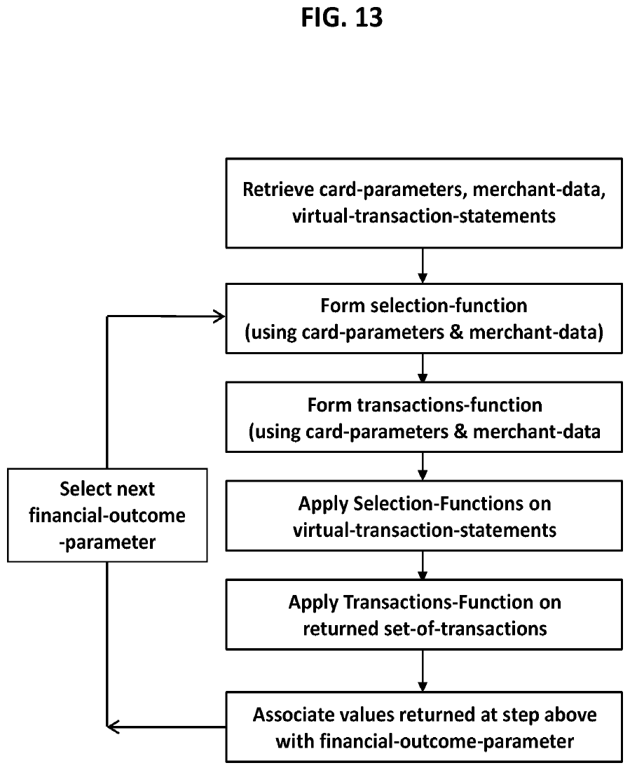

In an exemplary embodiment of the invention, device-400 may be used to determine financial-outcome-parameters (e.g. certain projected-rewards) as described hereinafter with reference to FIG. 13. Device-400 may determine a financial-outcome-parameter via a process including one or more of the following: retrieving virtual-transaction-statements; retrieving card-parameters for the specific card (e.g. rewards rate, rewards limit, fees, interest, etc.); retrieve merchant-data (e.g. merchant rewards); using merchant-data and card-parameters to form one or more selection-functions; using merchant-data (e.g. merchant rewards) and card-parameters (e.g. rewards rate, rewards limit, fees, interest, etc.) to form one or more transaction-functions; applying one or more of the selection-functions on virtual-transactions-statement and obtaining a set-of-transactions; applying one or more transaction-functions on transactions in the set-of-transactions returned by the selection-functions (or on the transactions in the virtual-transactions-statements if there is no selection-functions); saving the values returned by transaction-functions and associating them to the financial-outcome-parameter.

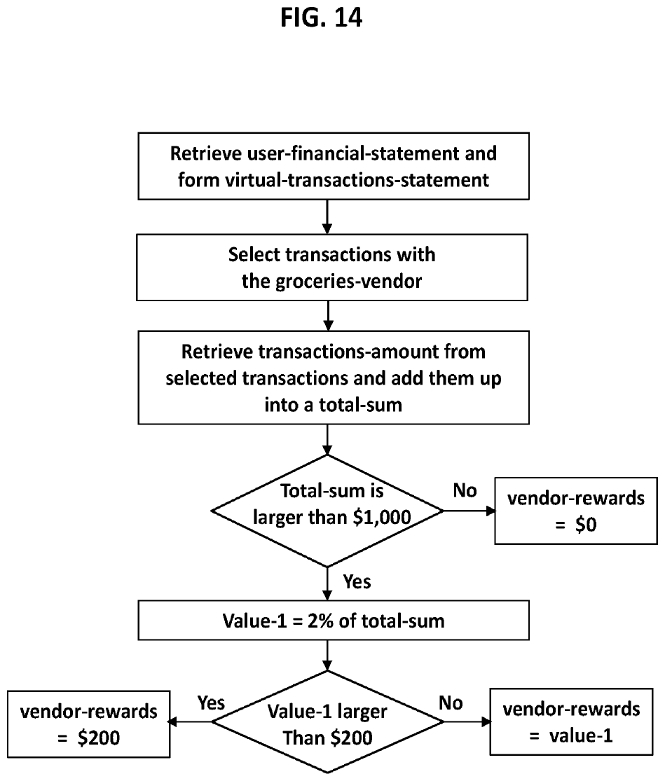

In the following it is explained, for exemplary purposes, how device-400 may be used to determine the vendor-rewards the user would receive, at the end of a one year period starting on Jul. 1, 2022, from a certain groceries-vendor assuming, for example, that the rewards policies of the groceries-vendor are as follow: rewards are awarded only for transactions with the groceries-vendor; rewards are awarded only if a spending-limit of $1,000 per year is reached; rewards are awarded at a rate of 2% of the total spending per year; the limit on total rewards is $200. In an exemplary embodiment of the invention, with reference to FIG. 14, device-400 may determine the total rewards the user would receive from the groceries-vendor at the end of the one year period as follows: device-400 retrieves user-financial-statement and forms virtual-transaction-statement; device-400 applies selection function selecting only transactions with the groceries-vendor; device-400 retrieves from the selected transactions the transactions-values and adds them up to a total-sum; device-400 checks to see if total-sum is larger than $1,000; if total-sum is larger than $1,000, the device-400 calculates a value-1 by multiplying total-sum with the 2% rewards rate; if value-1 is smaller than $200 then, the vendor-rewards is equal to value-1; if value-1 is larger than $200 then vendor-rewards are $200; if total-sum is smaller than $1,000 then vendor-rewards are zero.

The device-400 may use one of the rewards-conditions, rewards-formulas, and rewards-calculation-process to calculate rewards associated with specific transactions in the user-financial-statements. Device-400 may be configured to extract from the merchant-data a set of rewards-conditions, such as: merchant will provide a reward for a transaction only if the transaction-value is larger than $100, merchant will provide a reward for a transaction only if the transaction-date is in the month of November. The financial-outcome-parameters may include a transaction-rewards indicating the rewards user-A would receive if performing a the transaction via card-A at a time during the time-period-A. Consider a transaction-record corresponding to an individual transaction, wherein the transaction-record includes: a transaction-merchant, a transaction-value, and a transaction-date.

The rewards-calculation-process for a transaction-record may include: searching the merchant-data and determine if the merchant provides rewards for the transaction; verifying if the rewards-conditions are satisfied; if the rewards-conditions are satisfied, then extracting the merchant-parameters (e.g. merchant-rewards-rate; merchant-rewards-limit; merchant-cashback; merchant-spending-limit; etc.) from the merchant-data; then determine the transaction-rewards (e.g. value expressed in currency such as US dollar) by, for example, multiplying the transaction-value with a merchant-rewards-rate (e.g. expressed in percentage) provided by the merchant-data. In a similar manner, device-400 may calculate the transaction-rewards corresponding to each of the transactions in the virtual-financial-statement.

In another exemplary embodiment, device-400 is configured to create a rewards-formula for each of the transaction-records and to calculate the transaction-rewards by applying the rewards-formula to the transaction-record, card-info-record, and merchant-data.

Device-400 may calculate projected-rewards values for transactions satisfying one or more selection-criteria, such as: transactions conducted with a specific merchant; transactions conducted in a certain time-frame (e.g. two weeks around the Thanksgiving), transactions within a category of goods/services, transactions over a certain monetary value, etc.

In an exemplary embodiment the projected-rewards value for the transactions satisfying the selection criteria may be obtained by adding all the transaction-rewards (converted in same currency) corresponding to transactions satisfying the selection-criteria. In another exemplary embodiment, the device-400 may be configured to create one or more rewards-formulas and/or one or more rewards-calculation-processes for determining the projected-rewards for the selection-criteria. The rewards-formulas and/or the rewards-calculation-processes may use the one or more card-parameters of the card-offer-record. The skilled artisan would understand that various processes and formulas may be used without limitation to calculate the value of specific projected-rewards.

Device-400 may calculate projected rewards values for transactions associated with a certain merchant or vendor. In an exemplary embodiment the projected-rewards value for the merchant may be obtained by adding all the transaction-rewards, converted in same currency, corresponding to transactions with the merchant.

Device-400 may calculate projected-rewards value for transactions in a certain category of goods and services (e.g. groceries, healthcare, air-travel, hotels, gas, restaurants, utilities). In an exemplary embodiment the projected rewards value for the category of goods/services may be obtained by adding all the transaction-rewards, converted in same currency, corresponding to transactions for good/services in that category.

The device-400 may be configure to calculate the total projected-card-rewards 800 (hereinafter referred as total-card-rewards) the user would receive by using card-A during the time-period-A. In an exemplary embodiment, the device-400 may be configured to create one or more rewards-formulas and/or one or more rewards-calculation-processes for determining the total-card-rewards the user would receive by using the credit-card during the time-period. The rewards-formulas and/or the rewards-calculation-processes may use the one or more card-parameters of the card-offer-record.

The device-400 may be configured to convert each of the transaction-rewards into the most convenient currency (e.g. US dollar). For example, some of the transaction-rewards may be expressed in airline miles or in foreign currency. The device-400 is configured to determine the US dollar value or specific airline miles or foreign currency. In an exemplary embodiment, the value of the total-card-rewards may be obtained by first calculating the transaction-rewards for each of the individual transactions in the virtual-financial-statements; converting each of the transaction-rewards in a US dollars; then adding all the US dollar converted transaction-rewards for all the transactions in the virtual-financial-statement. The skilled artisan would understand that various processes and formulas may be used without limitation to calculate the value of the total-card-rewards.

Device-400 may calculate projected-rewards value for transactions satisfying one or more selection-criteria, such as: transactions conducted with a specific merchant; transactions conducted in a certain time-frame (e.g. two weeks around the Thanksgiving), transactions within a category of goods/services, transactions over a certain monetary value, etc. In an exemplary embodiment, the projected-rewards value for the transactions satisfying the selection criteria may be obtained by adding all the transaction-rewards (converted in same currency) corresponding to transactions (in the virtual-financial-statements) satisfying the selection-criteria. In another exemplary embodiment, the device-400 may be configured to create one or more rewards-formulas and/or one or more rewards-calculation-processes for determining the projected-rewards for the selection-criteria. The rewards-formulas and/or the rewards-calculation-processes may use the one or more card-parameters of the card-offer-record. The skilled artisan would understand that various processes and formulas may be used without limitation to calculate the value of specific projected-rewards.

Device-400 may calculate projected-rewards value for transactions in a certain category of goods and services (e.g. groceries, healthcare, air-travel, hotels, gas, restaurants, utilities). In an exemplary embodiment the projected rewards value for the category of goods/services may be obtained by adding all the transaction-rewards, converted in same currency, corresponding to transactions for good/services in that category.

The financial outcome prediction-system 100 may be able to make better predictions about the projected financial outcome and to determine more accurate values of financial-outcome-parameters, such as projected-rewards and overall-card-value, if the prediction-system takes into account information such as the user-input-information received at device-330 and auxiliary information's (e.g. market-information received at device-370 and information received at device-380) in addition to the user-financial-statements, the card-info-records, and the 840 merchant-data.

In an exemplary embodiment, device-400 may be configured to determine financial-outcome-parameters, such as projected-rewards, by taking into account the user-input-information received at device-330 and market-information received at device-360. In an exemplary embodiment of the invention, the outcome-function corresponding to the financial-outcome-parameter may be formed by a combination of selection-functions, transaction-functions and adjustment-functions, wherein the adjustment-functions are configured to incorporate and account for the effects on the financial-outcome-parameters brought by the user-input-information received at device-330 and of the market-information received at device-360

For each transaction-record in the virtual-transactions-statement, device-400 may be configured to calculate an adjustment-factor and/or adjustment-function corresponding to the transaction-record. In an exemplary embodiment, an improved transaction-reward value (hereinafter referred as improved-transaction-reward-value) may be obtained by multiplying the transaction-reward (i.e. transaction-reward obtained without using user-input-data and market-data, as described at above) with the corresponding adjustment-factor. In an exemplary embodiment, an improved-transaction-reward-value may be obtained by applying the adjustment-function to the transaction-reward. In an exemplary embodiment, improved financial-outcome-parameters may be obtained by applying adjustment-functions or adjustment-factors to transactions or subsets of transactions in the virtual-transactions-statement.

Device-400 may be configured to calculate improved-projected-rewards values for a 860 credit-card, by using improved-transaction-reward-values for each of the transactions. For example, the improved-projected-rewards-value may be calculated by first calculating the improved-transaction-rewards-value (adjusted via adjustment-factors and/or adjustment-functions) for each of the individual transactions in the virtual-transactions-statement; converting each of the transaction-rewards in one currency (e.g. US dollars); then adding all the currency converted improved-transaction-reward-values for all the transactions in the virtual-transactions-statement.

Device-400 may be configured to calculate improved-projected-rewards values for transactions satisfying certain selection-criteria (e.g. transaction is for a certain category of goods/service; transaction with a certain vendor; transactions in a certain time-period), by using improved-transaction-reward-values for each of the transactions. For example, the improved-projected-rewards-value for transactions associated with certain goods/services (e.g. groceries, wellness, utilities) may be calculated by first calculating the improved-transaction-rewards-value (adjusted via adjustment-factors and/or adjustment-functions) for each of the individual transactions associated with the goods/services; converting each of the transaction-rewards in one currency (e.g. US dollars); then adding all the currency converted improved-transaction-reward-values for all the transactions associated with the goods/services.

The adjustment-factors and adjustment-functions may be calculated by using the user-input-information and the market-information. For example, assume that an user has indicated via the user-input-information that in the next year he/she expects to spend three (3) times more on air-travel than she/he has spent during the time period of the financial-statement. In addition, assume that the market-information provides that the price of air-travel is expected to be one point three (1.3) times higher in the next year than during the financial-statement time period. Then the adjustment-factor for air-travel transactions may be calculated as the sum between 2 and 1.3 (i.e. 3.3). The skilled artisan would understand that various processes and formulas may be used without limitation to calculate the projected-rewards-value.

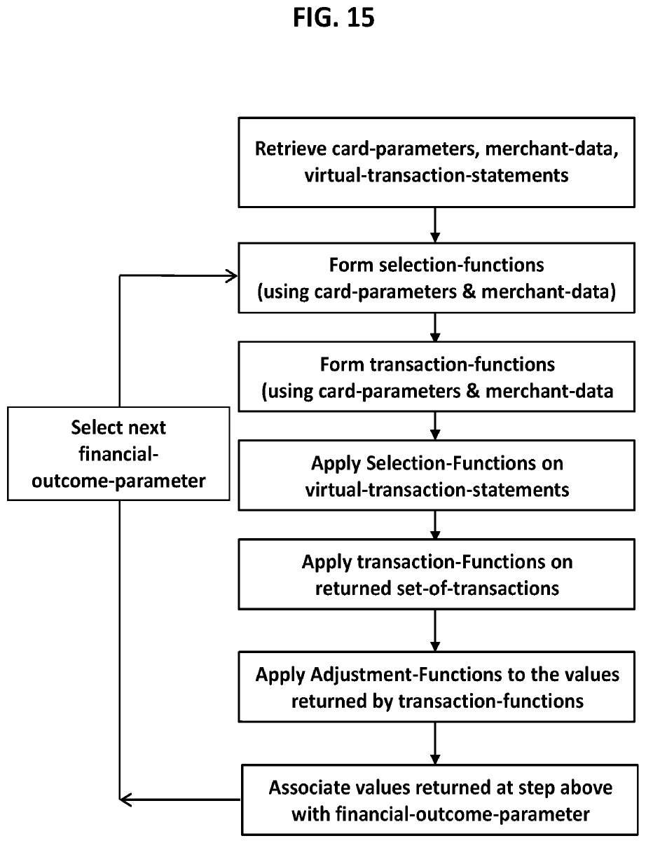

In an exemplary embodiment of the invention, device-400 may be used to determine financial-outcome-parameters (e.g. certain projected-rewards) as described hereinafter with reference to FIG. 15. Device-400 may determine a financial-outcome-parameter via a process including one or more of the following: retrieving virtual-transaction-statements; retrieving card-parameters for the specific card (e.g. rewards rate, rewards limit, fees, interest); retrieving merchant-data (e.g. merchant rewards); using merchant-data and card-parameters to form one or more selection-functions; using merchant-data (e.g. merchant rewards) and card-parameters (e.g. rewards rate, rewards limit, fees, interest, etc.) to form one or more transaction-functions; applying one or more of the selection-functions on virtual-transactions-statement and obtaining a set-of-transactions; applying one or more transaction-functions on transactions in the set-of-transactions returned by the selection-functions (or on the transactions in the virtual-transactions-statements if there is no selection-functions); applying one or more of the adjustment-functions to the values returned by the transaction-functions; saving the values returned by transaction-functions and associating them to the financial-outcome-parameter.

Device-400 may be configured to form an adjusted-virtual-transaction-statement including virtual-transactions updated via the adjustment-functions. Device-400 may be further configure to form a virtual-consolidated-activity-report including activity-parameters adjusted via the adjustment functions.

The device-400 may be configured to determine other financial-outcome-parameters, in addition to projected-rewards, such as: overall-card-value; total-cashback; total-fees; total-merchant-cashback; total-transaction-fees; total-merchant-fees; card-security-level; antitheft-protection-level; card-insurance; customer support level; ease of use (user friendly); foreign use index; etc.

Device-400 may be further configured to determine a monetary-value for each of the financial-outcome-parameters, such as: airline miles, hotel points, antitheft-protection-features, foreign currency rewards, card-insurance; customer support level, ease of use (user friendly), foreign use index, total-cashback, total-fees, total-merchant-fees, card-security-level, etc. Device-400 may be further configured to calculate an overall-card-value by adding the monetary values of all independent financial-outcome-parameters.

Device-400 may be configured to create a virtual-transaction-statements for a time-period (hereinafter referred as Time-2) which are different from the time-periods of the user-financial-statements (hereinafter referred as Time-1). For example, if the user-financial-statements are for one year, the device-400 may be configured to form a virtual-transaction-statement for 2 years, 3 years, and so on. In an exemplary embodiment, the device-400 may create a virtual-transaction-statement for the time period “Time-2” including transactions similar to the ones in the user-financial-statement but spaced/adjusted for the time period Time-2.

10. Device-500 for Listing, Filtering, Ranking and Recommending Credit Cards to Users

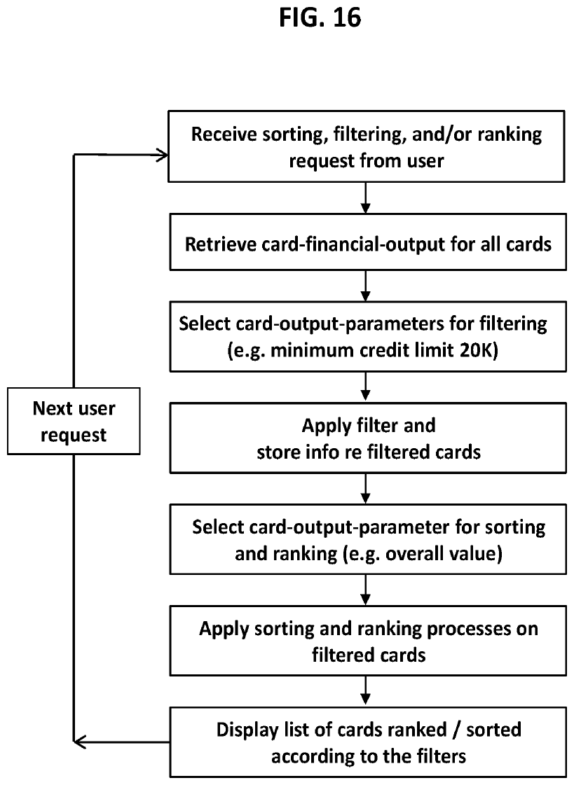

In an exemplary embodiment of the invention device-500 for listing, ranking, filtering, and recommending credit card offers to an user is described with reference to FIG. 16.

Device-500 is configured to create for each credit-card in the credit-card-database a user-card-profile including the projected-financial-outcome (e.g. including all financial-outcome-parameters) corresponding to the user using the credit-card and wherein the financial-outcome-parameters are calculated via device-400 as explained in the paragraphs above (e.g. card-m→projected financial-outcome-m [parameters: overall-card-value, rewards, fees, etc.]).

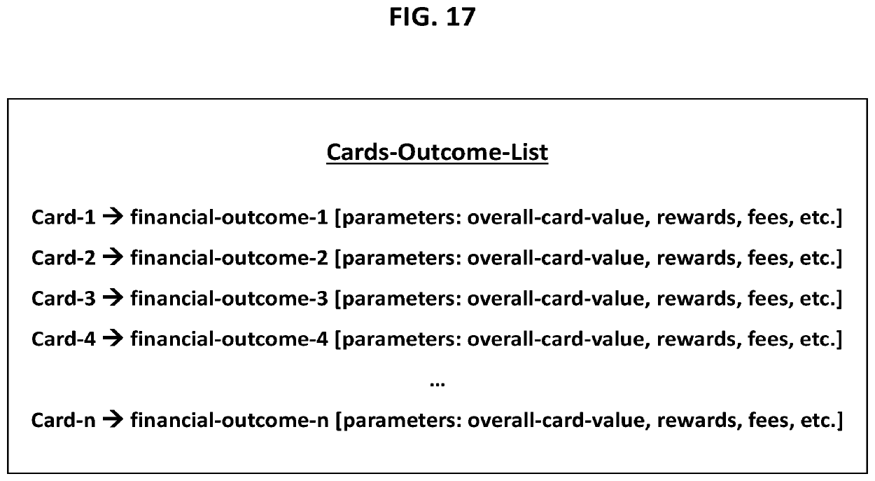

Device-500 may be configured to create one or more lists (hereinafter referred as cards-outcome-lists) including all user-card-profiles for each of the credit cards in the card-offer-database, as shown in FIG. 17. Device-500 is further configured to sort, rank and filter user-card-profiles in the cards-outcome-list according to the financial-outcome-parameters included by each card-profile. In an exemplary embodiment, device-500 is configured to sort the credit cards in the card-outcome-list according to the overall-card-value, and to display at an user device a list of the credit cards ranked according to the overall-card-value (the card with highest overall-card-value is highest on the list).

In another exemplary embodiment, device-500 is configured to rank the credit cards in the cards-outcome-list according to the projected-card-rewards, and to display at an user device a list of the credit cards ranked according to the projected-card-rewards.

In an exemplary embodiment, device-500 is configured to filter the credit cards in the credit-card-database according to certain conditions, such as: credit cards providing travel benefits, credit cards with no foreign transaction fees, credit cards with no annual fees, credit cards with cash back rewards, credit cards with low interest rate, credit cards with high security ratings, credit cards offered by certain financial institutions, etc. The credit cards returned by a filter may be ranked according to a financial-output-parameter such as overall-card-value.

The device-500 may be further configured to display the list of credit-cards returned by filtering, ranking and sorting at a user device such that the user can select the card most suitable for her/his circumstances. Device-500 includes one or more processors for performing the above sorting, filtering, and ranking operations; memories for storing information such as the cards-outcome-lists, and input/output devices for transferring information to be displayed at user devices and for receiving information from user devices.

Machine learning and artificial-intelligence methods may be applied to the information (e.g. metadata) gathered and created by the prediction-system-100 thereby providing additional benefits and offers to the user. It is understood that the prediction-system-100 is not only limited to credit card shopping and may be used to perform analysis of other benefits such as shopping offers, loan offers, optimizing bonus spending, etc.

The invention is not limited by the order of operations and the ways operations are aggregated. A skilled artisan would understand that operations can be aggregate/consolidated in various ways. Different embodiments use different orders of operations and aggregations/groupings

Reference to “one embodiment” or “an embodiment” means that a particular feature, structure, or characteristic described in the embodiment is not the only case for this patent. References to “embodiment” are not referring to the same embodiment, nor are separate or alternative embodiments mutually exclusive of others. The disclosure of various embodiments is intended to be illustrative, but not limiting, of the scope of the embodiments. Additionally, various features discussed in this document may be exhibited by some embodiments and not by others. Furthermore, various aforementioned requirements may be requirements for some embodiments but not others.

Unless clearly stated otherwise, the words “including,” “such as,” and the like are to be construed in the sense of “including, but not limited to.” Context permitting, the use of a singular or plural number may also include the plural or singular number respectively. When the word “or” is used in reference to a list of two or more items, it covers all of the following interpretations of the word: any of the items in the list, all of the items in the list, and any combination of the items in the list.

When it is written that a component or a feature “may,” “can,” “could,” or “might” be included or have a characteristic, that particular component or feature is not required to be included or have the characteristic.

The terminology used in the Detailed Description is intended to be interpreted in its broadest reasonable manner. The terms used in this specification generally have their ordinary meanings in the art, within the context of the disclosure, and in the specific context where each term is used. The use of examples in this document, including examples of any terms discussed herein, is illustrative only and is not intended to limit the scope and meaning of the disclosure or of any exemplified term. Likewise, the disclosure is not limited to various embodiments given in this specification.

Although only a few embodiments have been described in detail above, those skilled in the art can recognize that many variations from the described embodiments are possible without departing from the spirit of the invention. It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalent.

What is claimed is:

1. A system for determining financial-outcome-parameters of using a credit card, the system comprising:
(1). a device-1 configured to enable a user to open a user-account;
(2). a device-2 for accessing the user's financial-statements from one or more of user's financial-institutions, the financial-statements comprising a plurality of transactions;
(4). a device-4 configured to receive, from a computer on a network, information about a credit-card;
(5). a device-5 configured to receive, from one or more computers of the computer network, merchant-information; and
(6). a device-6 for determining one or more financial-outcome-parameters corresponding to the user using a credit-card during a future-time-period.

2. The system at claim 1, further comprising a device-7 for forming a user-financial-statement and a corresponding virtual-financial-statement,
(1). wherein the user-financial-statement comprises user-transaction-records corresponding to transactions of one or more of the financial-statements;
(2). wherein the user-financial-statement comprises a user-statement-start-date;
(3). wherein the virtual-financial-statement comprises a set of transaction-records, and each of the transaction-records in the set corresponds to a user-transaction-record in the user-financial- statement;
(4). wherein the virtual-financial-statement comprises a start-date equal to the first day of the future-time-period; and
(5). wherein each transaction-record comprises a transaction-date obtained by adding to the start-date a number of days equal to the difference between the user-transaction-date of the corresponding transaction and the user-statement-start-date.

3. The system at claim 2, wherein a financial-outcome-parameter is a rewards-parameter configured to estimate one or more rewards the user would receive if using the credit-card during the future-time-period and if user would perform the transactions in the virtual-transaction-records.

4. The system at claim 3, further comprising a device-8 for extracting card-information from the received credit-card, for using said card-information to form one or more rewards-functions, and for calculating the rewards-parameter by applying the rewards-functions to the virtual-card-statement.

5. The system of claim 4, wherein the rewards-parameter is configured to estimate the rewards a user would receive from a certain merchant, and wherein the rewards-functions are configured to select, out of transactions in the virtual statement, the transactions with the merchant.

6. The system of claim 4, wherein the reward-parameter is configured to estimate the rewards a user would receive from purchases in a certain category of goods and services, and wherein the rewards-functions are configured to select, out of transactions in the virtual-card-statement, the transactions in the certain category of goods and services.

7. The system of claim 2, wherein a financial-outcome-parameter is an overall-card-value configured to estimate the total overall value the user would receive if using the credit-card during the future-time-period, wherein the overall-card-value is determined by adding and subtracting monetary values of reward-parameters, monetary values of fee-parameters and monetary values other benefits associated with the credit-card.

8. The system of claim 2, further including a device-9 configured to receive user-input-information from the user and to determine expected user financial circumstances during the future time-period;
wherein transaction values corresponding to transaction-records of the virtual-transactions-statement are adjusted via one or more adjustment-functions such as to incorporate expected user financial circumstances.

9. The system of claim 8, wherein the expected user financial circumstances during the future time-period comprise one or more of the following: changes in expected spending on certain category of goods and services, changes in expected user income, expected use of other credit cards and payment methods, expected family circumstances.

10. The system at claim 2, further including a device-10 configured to receive, from one or more computers on the network, market-information about expected market conditions during the future time-period;
wherein transaction values corresponding to transaction-records of the virtual-transactions-statement are adjusted via one or more adjustment-functions such as to incorporate the market-information;
wherein the market-information comprises one or more of the following: expected inflation, expected changes in the price of goods and services, expected changes in interest rates.

11. The system at claim 10, further including the device-9.

12. The system at claim 11, further comprising a device-11 for extracting card-information from the received credit-card, for using said card-information to form one or more rewards-functions, and for calculating the rewards-parameter by applying the rewards-functions to the virtual-card-statement.

13. The system of claim 12, wherein the reward-parameter is configured to estimate the rewards a user would receive from purchases in a certain category of goods and services if using the credit-card during the future-time-period, and wherein the rewards-functions are configured to select, out of transactions in the virtual-card- statement, the transactions in the certain category of goods and services.

14. The system of claim 11, wherein a financial-outcome-parameter is an overall-card-value configured to estimate the total overall value the user would receive if using the credit-card during the future-time-period, wherein the overall-card-value is determined by adding and subtracting a monetary value of reward-parameters, fee-parameters and other benefits associated with the credit-card.

15. A system for recommending credit-cards, the system comprising:
(1). the system at claim 1 for determining financial-outcome-parameters of using a credit card;
(2). a device-12 configured to search a computer network for credit card offers, to receive from computers on the network card information about credit-cards, wherein the card information comprises one or more card-parameters;
(3). a device-13 for forming a list of credit-card-records, wherein each of the credit-card-records is associated with a credit-card, and wherein each of the credit-card-records comprises: one or more card-parameters and one or more financial-outcome-parameters determined, for the credit-card, via the system of claim 1;
(4). a device-14 enabling a user to filter and rank the credit-card-records according to one or more of the card-parameters and one or more of the financial-outcome-parameters determined via the system of claim 1.

16. The system for recommending credit-cards at claim 15, configured to rank the credit-card-records according to an overall-card-value and to display a ranked list of the credit-card-offers at a user's device.

17. A system for predicting user preference for a credit card, the system comprising:
(1). a device-1 configured to enable a user to open a user-account;
(2). a device-2 for accessing the user's financial-statements from one or more of user's financial-institutions, the financial-statements comprising a plurality of transactions;
(4). a device-3 configured to receive from a computer on a network information about one or several credit-cards;
(5). a device-4 configured to receive, from one or more computers of the computer network, merchant-information;
(6) a storage system-5 configured to store transactions, unique visit identifiers, and linking user transactions to unique visit identifiers;
(7) a storage system-6 configured to record user actions and linking said user actions to a unique visit identifier;
(8) a system-7 to compare transactions of the user during the current visit to prior user's transactions and user actions;
(6). a device-8 for predicting one or more financial-outcome-parameters corresponding to the user using a credit-card during a future-time-period.

18. The system of claim 17 where the outcome of interest is the choice of credit card made by a user during a visit.

19. The system of claim 17 where the outcome of interest is a categorical outcome including identifiers of credit cards users may choose to sign up for, as well as outcomes that indicate a lack of a choice of card, such as ending the visit prior to choosing a card to sign up for.

20. The system of claim 17 where a text analysis technique is applied to the user transaction and visit data.
